(19) United States
(12) Patent Application Publication
(10) Pub. No.: US 2009/0305902 A1
(43) Pub. Date: Dec. 10, 2009

(54) Double-Tiled and Multi-Tiled Arrays and Methods Thereof

(75) Inventors: Jef D. Boeke, Baltimore, MD (US); Sarah J. Wheelan, Baltimore, MD (US)

Correspondence Address: EDWARDS ANGELL PALMER & DODGE LLP, P.O. BOX 55874, BOSTON, MA, 02205, US

(73) Assignee: The Johns Hopkins University, Baltimore, MD (US)

(21) Appl. No.: 12/086,142

(22) PCT Filed: Dec. 12, 2006
(86) PCT No.: PCT/US2006/047497

§ 371 Date: Aug. 7, 2009

Related U.S. Application Data
(60) Provisional application No. 60/749,484, filed on Dec. 12, 2005.

(51) Int. Cl. C40B 30/04; C40B 40/06; C40B 50/00

(52) U.S. Cl. 506/9; 506/16; 506/23

(57) ABSTRACT

Described herein are multi-tiling methods that increases the number of features present on an array and methods of making and using the multi-tiled arrays. The arrays are useful, for example, for transcriptional profiling and genomic studies.

### RELATED APPLICATIONS

This application claims the benefit of U.S. Provisional Application No. 60/749,484, filed Dec. 12, 2005, the entire contents of which are incorporated herein by reference.

### BACKGROUND

Microarrays, high-throughput platforms for analyzing gene expression and features of total genomic DNA, among other things, are gaining in popularity as researchers discover ever more applications for their unbiased and broad feature sets and among the diagnostic industry for transcriptional profiling and polymorphism analysis. Microarray analyses are currently limited by the number of individual features that can be placed on each array, making the use of microarrays expensive and time consuming.

Microarrays, including genome tiling microarrays, are exceptionally powerful tools for querying diverse genomic features, including mapping gene expression and structure, analyzing polymorphisms, determining protein binding targets, and examining genome architecture¹⁻⁴. The utility of genome tiling microarrays lies in the unbiased selection of densely spaced features. Current microarrays and studies using them are restricted both by expense (the number of arrays or slides purchased) and by spatial limitations of microarray technology (the number of features on each array). Thus, there is a need in the art to increase the number of sequences present on an array to provide cost and timesavings.

### SUMMARY

Described herein is a multi-tiling method that significantly increases the number of features (e.g., sequences) present on an array and methods of making and using the multi-tiled array. For example, described herein, for the first time is successful transcriptional profiling using the multi-tiled array format. The described arrays and methods provide cost and timesavings as well as preserving precious samples. Using this method, we and others can now save money and precious samples by using fewer arrays to cover a region, or can perform investigations at significantly higher resolution without incurring increasing costs or increasing the amount of sample required for the experiment.

On aspect describes a double-tiling technique that effectively doubles the number of features, (e.g., sequences) fitting on any given array. For example, the double-tiling array is useful for complex, two-color, whole-genome hybridizations.

Provided herein, according to one aspect are multi-tiled nucleic acid arrays comprising an immobilized array of nucleic acid features, wherein each feature comprises an inner probe and an outer probe, wherein the inner and outer probes are unrelated in genomic coordinates.

In one embodiment, one of the inner or the outer probe is arranged horizontally and the other is arranged vertically. In a related embodiment, the features of the array further comprise middle probes between the inner and the outer probes, wherein the probes are unrelated in genomic coordinates. In another related embodiment, the features of the array further comprise second middle probes between the inner and the middle probes, wherein the probes are unrelated in genomic coordinates.

In one embodiment, the array may further comprise at least one positive control feature.

In one embodiment, the array may further comprise at least one negative control feature.

In one embodiment, the multi-tiled array comprises from between about 100 to about 3 billion features. In a related embodiment, multi-tiled array comprises from between about 10,000 to 10 million features. In a related embodiment, the multi-tiled array comprises from between about 1000 to about 5 million features. The arrays described herein may have any number of features as determined appropriate by one of skill in the art for a particular purpose.

Provided herein, according to one aspect are multi-tiled nucleic acid arrays comprising an immobilized array of nucleic acid features, wherein the features comprise an inner probe, a middle probe, and an outer probe, wherein the probes are unrelated in genomic coordinates.

In one embodiment, the probes are from between about 10 nucleotides to about 50 nucleotides in length. In a related embodiment, the probes are from between about 15 nucleotides to about 40 nucleotides in length. In another related embodiment, the probes are from between about 20 nucleotides to about 35 nucleotides in length. In a related embodiment, the probes are 30 nucleotides in length.

In one embodiment, the inner, middle, and outer probes are arranged horizontally, vertically and diagonally, respectively or in any order. The probes on a multi-tiled array of a certain layer are arranged in one manner different from those in another layer. It does not matter which layer is arranged in which manner. Layers of probes may also be arranged in non-linear or random patterns.

In one embodiment, the features further comprise spacers between the inner and the middle probe and between the middle and the outer probe.

Provided herein, according to one aspect are multi-tiled nucleic acid arrays comprising an immobilized array of nucleic acid features, wherein the features comprise four probes, an inner probe a middle probe, and an outer probe, wherein the probes are unrelated in genomic coordinates.

In one embodiment the probes are from between about 10 nucleotides to about 50 nucleotides in length.

In one embodiment, the probes are arranged horizontally, vertically, diagonally upper left to lower right and diagonally lower left to upper right. In a related embodiment, the features further comprise spacers between the inner and the middle probe and between the middle and the outer probe.

Provided herein, according to one aspect are multi-tiled nucleic acid arrays comprising an immobilized array of nucleic acid features, wherein the features comprise at least two probes unrelated in genomic coordinates. In a related embodiment, the features comprise three probes. In another related embodiment, the features comprise four probes.

Provided herein, according to one aspect are methods of expression (transcriptional) profiling, comprising providing a multi-tiled array, hybridizing a labeled sample to the array; and analyzing the array.

In one embodiment, the array comprises portions of at least one genome. Exemplary genomes include, for example, mammals, yeast, bacteria, plants, and the like.

In one embodiment, the profiling further comprises comparing the expression profile of a sample to an expression profile reference.

In one embodiment, the sample is a clinical sample.

In one embodiment, analyzing the array comprises deconvolution of a signal.

In one embodiment, the analyzing determines an expression profile of a sample.

In one embodiment, the method of expression profiling evaluates a subject for a condition.

In one embodiment, the condition is a disease condition.

In one embodiment, the method of expression profiling diagnoses a subject for a condition. In a related embodiment, the method of expression profiling monitors a subject for a condition. In another related embodiment, the subject is a human.

Provided herein, according to one aspect are methods of constructing a multi-tiled array (of increasing features of an array), comprising selecting probe sequences; arranging inner probe sequences in sequence order, and appending outer probe sequences in sequence order to the inner probe sequences.

In one embodiment, the methods may further comprise masking a genome of an organism prior to selecting probe sequences.

In one embodiment, one of the inner or the outer probe sequences are arranged horizontally and the other are arranged vertically.

In one embodiment, the array may further comprise appending third probe sequences in sequence order to the outer probe sequences.

In one embodiment, the third probe sequences are arranged diagonally.

In one embodiment, selecting the probe sequences comprises selecting one or more of random sequence or sequences with low probability of conformational problems.

In one embodiment, the methods may further comprise randomizing the positions of the sequences. In one embodiment, the methods may further comprise adding a spacer between the inner and the outer probe.

In one embodiment, the masking comprises masking repetitive genomic sequences.

In one embodiment, the selecting of the probes comprises separating each probe by at least a distance of 1 to 500 nucleotides. In a related embodiment, the selecting of the probes comprises separating each probe by a distance of between about 1 to about 1,000 nucleotides.

Provided herein, according to one aspect are methods of array based evaluation of a sample, comprising providing a multi-tiled array; hybridizing a sample to the array; and deconvoluting signal intensities.

In one embodiment, the methods may further comprise analyzing the signal intensities.

In one embodiment, the methods may further comprise examining fluorescent feature adjacency to determine whether the inner or outer probe was hybridized.

In one embodiment, the signal is a fluorescent or color signal. In one embodiment, the methods may further comprise preparing a sample. In a related embodiment, preparing the sample comprises one or more of digesting a sample, labeling a digested sample, and purifying sample. In a related embodiment, deconvoluting comprises visualizing the microarray and examining the data obtained from the microarray.

In one embodiment, digesting a sample for cDNA synthesis may be by using MMLV-RT, DTT, 10 mM DNTP and RNaseOUT (Agilent Technologies Kit) or Agilent Low RNA Input Linear Amplification Kit. In one embodiment, labeling a digested sample is by in vitro transcription. In another embodiment, purifying sample is, for example, by QIAGEN's QIAquick spin columns as described in the RNeasy Mini Kit (QIAGEN).

In another embodiment, deconvoluting comprises visualizing the microarray. In a related embodiment, the visualizing is, for example, by Axon GenePix 4,000B scanner (Axon Instruments). In another embodiment, the data generated from the deconvolution and the visualization is examined, for example, by using GenePix Pro 6.0.

Provided herein, according to one aspect are methods of polymorphism analysis comprising providing a multi-tiled nucleic acid array of probes comprising a first set of probes spanning each of a collection of polymorphic sites in known sequences of unknown function and complementary to a first allelic forms of the sites, and a second set of probes spanning each of the polymorphic sites in the collection and complementary to second allelic forms of the sites, wherein the collection of polymorphic sites includes at least 10 unlinked polymorphic sites; and hybridizing a nucleic acid sample from a subject to the array of probes and analyzing the hybridization intensities of probes in the first and second probe sets to determine a profile of polymorphic forms present in the individual.

Provided herein, according to one aspect are methods for constructing a multi-tiled chemical array comprising a plurality of features of bioorganic molecules in a predetermined arrangement, comprising providing a substantially planar solid material having an attachment surface; and attaching the features of bioorganic molecules onto the attachment surface, wherein the features comprise an inner probe and an outer probe, wherein the inner and outer probes are unrelated in genomic coordinates.

In one embodiment, the array comprises from about 50 to about 3 billion (3×10e9) different features of the bioorganic molecules and wherein the bioorganic molecules are attached to the surface of each the tile at a density of about 1000 to 100,000 bioorganic molecules per square micron of the attachment surface.

In one embodiment, the material comprises a solid nonporous material selected from the group consisting of a glass, a silicon, and a plastic.

In one embodiment, the methods may further comprise bringing the constructed array into contact with a same sample.

In one embodiment, the methods may further comprise performing a quality test on the attachment surface after the attaching.

In one embodiment, the methods may further comprise verifying the fidelity of the bioorganic molecules on the attachment surface.

In one embodiment, the methods may further comprise verifying the density of attachment of the bioorganic molecules on the attachment surface.

In one embodiment, the bioorganic molecules are presynthesized before attachment onto the surface.

Provided herein, according to one aspect are kits for use in expression profiling of a nucleic acid comprising a multi-tiled nucleic acid array-, and instructions for use.

### BRIEF DESCRIPTION OF THE DRAWINGS

FIG. 1 depicts a sample 4×4 array for didactic purposes. (a) The sequence to be tiled is split into two equal-length segments, represented here as first half, A-P; second half, 1-16. 30-mers from each half-sequence are tiled separately, A-P (inner stack) horizontally and 1-16 (outer stack) vertically. (b) Outer stack tiles are overlaid on inner stack tiles and the 32 30-mers are concatenated to form 16 60-mers.

FIG. 2 depicts a plasmid experiment—results agree well with predictions. (a) Virtual array, produced in HTML by Perl scripts, showing the idealized hybridization of the plasmid mixture to the features. The signal from HIS4 and adjacent sequences (YCL plasmid) is discontinuous due to disruptions by mandatory Agilent control features. (b) Actual experimental results, showing illumination of features by binding to the fluorescent extract Inset: detail of intersection of horizontal and vertical lines. (c) Overlay of virtual and experimental results. Red indicates features expected to be bound that are actually bound in (b). Yellow dots (5.6% of total features shown) are predicted to hybridize but do not actually hybridize at high levels. Blue dots (also 5.6% of total) indicate features that are bound experimentally but not expected to hybridize, given the pattern in (a).

FIG. 3 depicts a two-color double-tiled array clearly demonstrating galactose induction. A section of the two-color double-tiled array, showing red signal in lines resulting from hybridization of Cy5-labeled RNA from galactose-induced cultures along with Cy3-labeled RNA from glucose-induced cultures. Most lines are yellow, indicating that as expected, most genes are expressed at similar levels in the glucose- and galactose-grown cultures. The features illuminated in a horizontal red line are derived from GAL1; the vertical red line is signal from GAL2. Unexpectedly, native Ty1 sequences were found to be downregulated approximately 2.5 fold by galactose induction; this conclusion was confirmed by real-time RT-PCR.

FIG. 4 depicts a double-tiled arrays show low between-array variation. Box plots showing the distribution of difference between estimated relative expression obtained from replicate RNA samples. Ideally, these differences should be 0; thus, tighter box plots are associated with better precision. The first box plot (green) represents the data from double-tiled arrays and the second plot represents data from conventional single-tiled arrays.

FIG. 5 shows correspondence at the top (CAT) plots. Correspondence, shown in the y-axis, is defined as the number of genes in common in lists formed by ranking genes by their log-ratios and keeping the top N. The size of the list N is varied and shown in the x-axis. In this plot we show correspondence between arrays hybridized to replicate samples. The blue line shows correspondence between two replicate single-tiled arrays, the red represents correspondence between two replicate double-tiled arrays, and the green line shows the average correspondence between single-tiled and double tiled arrays (there are 4 possible comparisons, all shown in thinner lines). The yellow area represents a 99.9% critical region for the null hypothesis of no correspondence, i.e. anything outside this region attains a p-value of less than 0.001.

### DETAILED DESCRIPTION

Before the invention is described in detail, it is to be understood that this invention is not limited to the particular component parts or process steps of the methods described, as such parts and methods may vary. It is also to be understood that the terminology used herein is for purposes of describing particular embodiments only, and is not intended to be limiting. As used in the specification and the appended claims, the singular forms “a”, an and “the” include plural referents unless the context clearly indicates otherwise.

Throughout this disclosure, various aspects of this invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

The practice of the present invention may employ, unless otherwise indicated, conventional techniques and descriptions of organic chemistry, polymer technology, molecular biology (including recombinant techniques), cell biology, biochemistry, and immunology, which are within the skill of the art. Such conventional techniques include polymer array synthesis, hybridization, ligation, and detection of hybridization using a label. Specific illustrations of suitable techniques can be had by reference to the example herein below. However, other equivalent conventional procedures can, of course, also be used. Such conventional techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press), Stryer, L. (1995) Biochemistry (4th Ed.) Freeman, N.Y., Gait, “Oligonucleotide Synthesis: A Practical Approach” 1984, IRL Press, London, Nelson and Cox (2000), Lehninger, Principles of Biochemistry 3.sup.rd Ed., W.H. Freeman Pub., New York, N.Y. and Berg et al. (2002) Biochemistry, 5.sup.th Ed., W.H. Freeman Pub., New York, N.Y., all of which are herein incorporated in their entirety by reference for all purposes. The present invention can employ solid substrates, including arrays in some preferred embodiments. Methods and techniques applicable to polymer (including protein) array synthesis have been described in U.S. Ser. No. 09/536,841, WO 00/58516, U.S. Pat. Nos. 5,143,854, 5,242,974, 5,252,743, 5,324,633, 5,384,261, 5,405,783, 5,424,186, 5,451,683, 5,482,867, 5,491,074, 5,527,681, 5,550,215, 5,571,639, 5,578,832, 5,593,839, 5,599,695, 5,624,711, 5,631,734, 5,795,716, 5,831,070, 5,837,832, 5,856,101, 5,858,659, 5,936,324, 5,968,740, 5,974,164, 5,981,185, 5,981,956, 6,025,601, 6,033,860, 6,040,193, 6,090,555, 6,136,269, 6,269,846 and 6,428,752, in PCT Applications Nos. PCT/US99/00730 (International Publication Number WO 99/36760) and PCT/US01/04285, which are all incorporated herein by reference in their entirety for all purposes.

In this specification and in the claims that follow, reference will be made to a number of terms which are used as defined below.

An “array” is an arrangement of objects in space in which each object occupies a separate predetermined spatial position. Each of the objects in the array of this invention comprises one or more species of chemical moiety attached to a “discrete physical entity”, such that the physical location of each species is known or ascertainable. A “discrete physical entity” is a unit of substantially planar material (e.g., a solid material, a membrane, a gel or a combination of materials) that can be handled and still maintain its identity, and can be subdivided into “tiles” for recombining in various ways to form a physical array. Preferably, the tiles will have regular geometric shapes, e.g., a sector of a circle, a rectangle, and the like, with radial or linear dimensions of about 100 mm to about 10 mm, most preferably about 1 μM to about 1000 μM. The subdivision of the entity into tiles can be made either before or after attachment of the chemical moiety, and by any suitable method for cutting the entity, e.g., with a dicing saw. These methods are well known in the art of semiconductor chip manufacture and can be optimized by one skilled in the art for the particular material selected for use in this invention.

A “support” is a surface or structure for the attachment of tiles. The “support” may be of any desired shape and size and can be fabricated from a variety of materials. The support material can be treated for biocompatibility (i.e., to protect biological samples and probes from undesired structure or activity changes upon contact with the support surface) and to reduce non-specific binding of biological materials to the support. These procedures are well known in the art (see, e.g., Schoneich et al, Anal. Chem. 65: 67-84R (1993)). The tiles can be attached to the support by means of an adhesive, by insertion into a pocket or channel formed in the support, or by any other means that will provide a stable and secure spatial arrangement.

“Tiling” is the process of forming an array by picking and placing individual tiles comprising single or multiple species of chemical moieties (referred to as “features”) on a support in a fixed spatial pattern.

“Multi-tiling,” as used herein, refers for example to an array in which the individual features contain two or more non-contiguous sequences directly or indirectly associated or bound to form the feature. The multi-tiled arrays are useful, for example, for complex, two-color, whole-genome hybridizations, transcriptional profiling, mapping gene expression and structure, analyzing polymorphisms, determining protein binding targets, and examining genome architecture. The genome tiling microarrays allow for the unbiased selection of densely spaced features. As an example, double-tiling effectively doubles the number of sequences fitting on any given array as each feature has an inner and an outer probe. In one embodiment of a double-tiled array, a 60-mer feature for DNA oligonucleotide microarrays each comprise two concatenated 30-mers. The features may be, for example, in the context of a double-tiled array, from between about 10 to about 200-mers. For example, the features may be made of two 5, 10, 15, 20, 25, 30, 40, 50, 60, 70, 75, 80, 85, 90, 95, or 100-mers. The oligonucleotides features in a double-tiled array may be concatenated, spaced by a linker to which they are both bound or associated or otherwise attached or associated to form a feature of the array.

The features of a multi-tiled array may be arranged in linear, non-linear, or random patterns. For example, in the context of a double-tiled array, the inner probe of the feature, which is directly or indirectly bound or associated with the substrate, may be in a horizontal arrangement while the outer probe of the feature will be in a vertical arrangement or vice versa. One of the features may also be in, for example, a diagonal arrangement. In a triple-tiled arrangement, for example, the inner probe is in a diagonal arrangement, the middle probe is in a horizontal arrangement and the outer probe is in a vertical arrangement. The probes of a feature are unrelated in genomic coordinate or sequence arrangement from the other probes of a feature.

The positions of the sequences of the features may be randomized to reduce potential spatial artifacts.

In one embodiment, probes in one arrangement (e.g., the inner probes of a feature) will span contiguous sequences or may be separated by some distance. For example, the inner probes of a feature may be separated by from about 10 to about 500 nucleotides. The probes may be separated by about 10, 20, 30, 40, 50, 60, 70, 80, 90, 100, 120, 130, 140, 150, 160, 170, 180, 190, or about 200 nucleotides. The probes may be separated by any number of nucleotides determined to give the optimal sequence coverage as determined by one of skill in the art depending on the purpose of the array or the experiment or diagnostic the array is being used for. For example, in a sample, the fluorescent polynucleotides will span a contiguous set of sequences or probes on an array illuminating a line of features. By examining fluorescent feature adjacency, one can easily determine whether the inner or outer probe, as a fluorescent molecule binding one outer probe will bind several adjacent outer probes, illuminating a horizontal vs. vertical line of features. If the features are randomized, they can be computationally “derandomized” and the adjacency patterns will be apparent.

An array may be made of any number of features as known in the art. For example, a 44,000 feature (60-mer) array of the (Agilent Technologies Inc.) spanning the entire Saccharomyces cerevisiae genome is an example. Other genomes may be made into arrays and may be designed as described herein or by other methods known to those of skill in the art, e.g., vertebrate, mammals, plants, etc. To adequately cover a genome, repetitive sequences (e.g., retrotransposons and long terminal repeats (LTRs), telomeres, and X and Y′ elements) may be masked at the feature selection stage. An array may also contain positive and/or negative controls. Positive controls may be made of sequences that are known to be in a sample of interest or may be added to a sample and the features may be added to the array of those sequences. Exemplary positive controls include the Ty1 sequences for a yeast array. In selecting sequences of a genome to be probes, programs such as Primer3⁹ and the like may be used to choose oligonucleotides with the lowest likelihood of conformational problems. Sequences may also be selected randomly or by any other method suitable for a particular purpose.

“Deconvolution,” as used herein, refers to computationally or otherwise analyzing which probe in a feature is bound by sample. None of the probes, each probe of a feature may be bound or one or more probes of a feature may be bound by sample. One method of deconvolution is to define yᵢ as the normalized log ratio of the red versus green intensity for feature i. Then assume that the contribution of each component was additive and used the following linear model: yᵢ=θgᵢ₁+θgᵢ₂+ε, where gᵢ₁ is the index of the inside gene and gᵢ₂ is the index of the outside gene, θgᵢ is the relative expression for each gene, and ε represents measurement error. Estimate θgᵢ for all gᵢ. Assumed the errors were independently identically distributed with mean 0 and used the least squares method. In one embodiment, for example with an array having 44,290 features, create a 44,290×6,606 design matrix, X, with rows representing features and columns representing the open reading frames (ORFs) in the Saccharomyces Gene Database annotation file, with a 1 placed at position xⱼₖ if ORF j is represented on feature k. Then denote the 6606×1 vector of true relative gene expression for each gene with Θ and the 44,290×1 vector of log ratios and errors with y and ε respectively. The model could then be written as: y=XΘ+\vec{ε} and the least squares solution is: \hat{Θ}=(X^{T}X)⁻¹X^{T}y. This is the matrix form of the multiple regression equations. Solving this equation involves inverting a 6,606×6,606 matrix. Taking advantage of X as an extremely sparse matrix and solve the equation using the Matrix package in R (http://cran.r-project.org/src/contrib/Descriptions/Matrix.html).

A “chemical moiety” is an organic or inorganic molecule that is preformed at the time of attachment to a discrete physical moiety, in distinction to an organic molecule that is synthesized in situ on an array surface. The preferred mode of attachment is by covalent bonding, although noncovalent means of attachment or immobilization might be appropriate depending on the particular type of chemical moiety that is used. If desired, a “chemical moiety” can be covalently modified by the addition or removal of groups after the moiety is attached to a physically distinct entity.

The chemical moieties of this invention are preferably “bioorganic molecules” of natural or synthetic origin, are capable of synthesis or replication by chemical, biochemical or molecular biological methods, and are capable of interacting with biological systems, e.g., cell receptors, immune system components, growth factors, components of the extracellular matrix, DNA and RNA, and the like. The preferred bioorganic molecules for use in the arrays of this invention are “molecular probes” selected from nucleic acids (or portions thereof), proteins (or portions thereof), polysaccharides (or portions thereof), and lipids (or portions thereof), for example, oligonucleotides, peptides, oligosaccharides or lipid groups that are capable of use in molecular recognition and affinity-based binding assays (e.g., antigen-antibody, receptor-ligand, nucleic acid-protein, nucleic acid-nucleic acid, and the like). An array may contain different families of bioorganic molecule, e.g., proteins and nucleic acids, but typically will contain two or more species of the same family of molecule, e.g., two or more sequences of oligonucleotide, two or more protein antigens, two or more chemically distinct small organic molecules, and the like. An array can be formed from two species of molecule, although it is preferred that the array contain several tens to thousands of species of molecule, preferably from about 50 to about 1000 species. Each species of course can be present in multiple copies if desired.

An “analyte” is a molecule whose detection is desired and which selectively or specifically binds to a molecular probe. An analyte can be the same or different type of molecule as the molecular probe to which it binds.

The term “complementary” as used herein refers to the hybridization or base pairing between nucleotides or nucleic acids, such as, for instance, between the two strands of a double stranded DNA molecule or between an oligonucleotide primer and a primer binding site on a single stranded nucleic acid to be sequenced or amplified. Complementary nucleotides are, generally, A and T (or A and U), or C and G. Two single stranded RNA or DNA molecules are said to be complementary when the nucleotides of one strand, optimally aligned and compared and with appropriate nucleotide insertions or deletions, pair with at least about 80% of the nucleotides of the other strand, usually at least about 90% to 95%, and more preferably from about 98 to 100%. Alternatively, complementarity exists when an RNA or DNA strand will hybridize under selective hybridization conditions to its complement. Typically, selective hybridization will occur when there is at least about 65% complementary over a stretch of at least 14 to 25 nucleotides, preferably at least about 75%, more preferably at least about 90% complementary. See, M. Kanehisa Nucleic Acids Res. 12:203 (1984), incorporated herein by reference.

The term “detectable moiety” (Q) means a chemical group that provides a signal. The signal is detectable by any suitable means, including spectroscopic, photochemical, biochemical, immunochemical, electrical, optical or chemical means. In certain cases, the signal is detectable by 2 or more means.

The detectable moiety provides the signal either directly or indirectly. A direct signal is produced where the labeling group spontaneously emits a signal, or generates a signal upon the introduction of a suitable stimulus. Radiolabels, such as ³H, ¹²⁵I, ³⁵S, ¹⁴C or ³²P, and magnetic particles, such as Dynabeads™, are nonlimiting examples of groups that directly and spontaneously provide a signal Labeling groups that directly provide a signal in the presence of a stimulus include the following nonlimiting examples: colloidal gold (40-80 nm diameter), which scatters green light with high efficiency; fluorescent labels, such as fluorescein, Texas red, Rhoda mine, and green fluorescent protein (Molecular Probes, Eugene, Oreg.), which absorb and subsequently emit light; chemiluminescent or bioluminescent labels, such as luminol, lophine, acridine salts and luciferins, which are electronically excited as the result of a chemical or biological reaction and subsequently emit light; spin labels, such as vanadium, copper, iron, manganese and nitroxide free radicals, which are detected by electron spin resonance (ESR) spectroscopy; dyes, such as quinoline dyes, triarylmethane dyes and acridine dyes, which absorb specific wavelengths of light; and colored glass or plastic (e.g., polystyrene, polypropylene, latex, etc.) beads. See U.S. Pat. Nos. 3,817,837; 3,850,752; 3,939,350; 3,996,345; 4,277,437; 4,275,149 and 4,366,241.

A detectable moiety provides an indirect signal where it interacts with a second compound that spontaneously emits a signal, or generates a signal upon the introduction of a suitable stimulus. Biotin, for example, produces a signal by forming a conjugate with streptavidin, which is then detected. See Hybridization With Nucleic Acid Probes. In Laboratory Techniques in Biochemistry and Molecular Biology; Tijssen, P., Ed.; Elsevier. New York, 1993; Vol. 24. An enzyme, such as horseradish peroxidase or alkaline phosphatase, that is attached to an antibody in a label-antibody-antibody as in an ELISA assay, also produces an indirect signal.

A preferred detectable moiety is a fluorescent group. Fluorescent groups typically produce a high signal to noise ratio, thereby providing increased resolution and sensitivity in a detection procedure. Preferably, the fluorescent group absorbs light with a wavelength above about 300 nm, more preferably above about 350 nm, and most preferably above about 400 nm. The wavelength of the light emitted by the fluorescent group is preferably above about 310 nm, more preferably above about 360 nm, and most preferably above about 410 nm.

The fluorescent detectable moiety is selected from a variety of structural classes, including the following nonlimiting examples: 1- and 2-aminonaphthalene, p,p′diaminostilbenes, pyrenes, quaternary phenanthridine salts, 9-aminoacridines, p,p′-diaminobenzophenone imines, anthracenes, oxacarbocyanine, marocyanine, 3-aminoequilenin, perylene, bisbenzoxazole, bis-p-oxazolyl benzene, 1,2-benzophenazin, retinol, bis-3-aminopridinium salts, hellebrigenin, tetracycline, sterophenol, benzimidazolyl phenylamine, 2-oxo-3-chromen, indole, xanthen, 7-hydroxycoumarin, phenoxazine, salicylate, strophanthidin, porphyrins, triarylmethanes, flavin, xanthene dyes (e.g., fluorescein and rhodamine dyes); cyanine dyes; 4,4-difluoro-4-bora-3a,4a-diaza-s-indacene dyes and fluorescent proteins (e.g., green fluorescent protein, phycobiliprotein).

A number of fluorescent compounds are suitable for incorporation into the present invention. Nonlimiting examples of such compounds include the following: dansyl chloride; fluoresceins, such as 3,6-dihydroxy-9-phenylxanthhydrol; rhodamineisothiocyanate; N-phenyl-1-amino-8-sulfonatonaphthalene; N-phenyl-2-amino-6-sulfonatonaphthanlene; 4-acetamido-4-isothiocyanatostilbene-2,2′-disulfonic acid; pyrene-3-sulfonic acid; 2-toluidinonapththalene-6-sulfonate; N-phenyl, N-methyl 2-aminonaphthalene-6-sulfonate; ethidium bromide; stebrine; auroniine-0,2-(9′-anthroyl)palmitate; dansyl phosphatidylethanolamin; N,N′-dioctadecyl oxacarbocycanine; N,N′-dihexyl oxacarbocyanine; merocyanine, 4-(3′-pyrenyl)butryate; d-3-aminodesoxy-equilenin; 12-(9′-anthroyl)stearate; 2-methylanthracene; 9-vinylanthracene; 2,2′-(vinylene-p-phenylene)bisbenzoxazole; β-bis[2-(4-methyl-5-phenyl oxazolyl)]benzene; 6-dimethylamino-1,2-benzophenzin; retinol; bis(3′-aminopyridinium)-1,10-decandiyl diiodide; sulfonaphthylhydrazone of hellibrienin; chlorotetracycline; N-(7-dimethylaminomethyl-2-oxo-3-chromenyl)maleimide; N-[p-(2-benzimidazolyl)phenyl]maleimide; N-(4-fluoranthyl)maleimide; bis(homovanillic acid); resazarin; 4-chloro-7-nitro-2,1,3-benzooxadizole; merocyanine 540; resorufin; rose bengal and 2,4-diphenyl-3(2H)-furanone. Preferably, the fluorescent detectable moiety is a fluorescein or rhodamine dye.

Another preferred detectable moiety is colloidal gold. The colloidal gold particle is typically 40 to 80 nm in diameter. The colloidal gold may be attached to a labeling compound in a variety of ways. In one embodiment, the linker moiety of the nucleic acid labeling compound terminates in a thiol group (—SH), and the thiol group is directly bound to colloidal gold through a dative bond. See Mirkin et al. Nature 1996, 382, 607-609. In another embodiment, it is attached indirectly, for instance through the interaction between colloidal gold conjugates of antibiotin and a biotinylated labeling compound. The detection of the gold labeled compound may be enhanced through the use of a silver enhancement method. See Danscher et al. J. Histotech 1993, 16, 201-207.

The term “effective amount” as used herein refers to an amount sufficient to induce a desired result.

The term “fragmentation” refers to the breaking of nucleic acid molecules into smaller nucleic acid fragments. In certain embodiments, the size of the fragments generated during fragmentation can be controlled such that the size of fragments is distributed about a certain predetermined nucleic acid length.

The term “genome” as used herein is all the genetic material in the chromosomes of an organism. DNA derived from the genetic material in the chromosomes of a particular organism is genomic DNA. A genomic library is a collection of clones made from a set of randomly generated overlapping DNA fragments representing the entire genome of an organism.

The term “hybridization” as used herein refers to the process in which two single-stranded polynucleotides bind non-covalently to form a stable double-helix polynucleotide; triple-stranded hybridization is also theoretically possible. The resulting (usually) double-stranded polynucleotide is a “hybrid.” The proportion of the population of polynucleotides that forms stable hybrids is referred to herein as the “degree of hybridization.” Hybridizations are usually performed under stringent conditions, for example, at a salt concentration of no more than 1 M and a temperature of at least 25° C. For example, conditions of 5.times.SSPE (750 mM NaCl, 50 mM NaPhosphate, 5 mM EDTA, pH 7.4) and a temperature of 25-30° C. are suitable for allele-specific probe hybridizations. For stringent conditions, see, for example, Sambrook, Fritsche and Maniatis. “Molecular Cloning A laboratory Manual” 2.sup.nd Ed. Cold Spring Harbor Press (1989) which is hereby incorporated by reference in its entirety for all purposes above.

The term “hybridization conditions” as used herein will typically include salt concentrations of less than about 1 M, more usually less than about 500 mM and preferably less than about 200 mM. Hybridization temperatures can be as low as 5° C., but are typically greater than 22° C., more typically greater than about 30° C., and preferably in excess of about 37° C. Longer fragments may require higher hybridization temperatures for specific hybridization. As other factors may affect the stringency of hybridization, including base composition and length of the complementary strands, presence of organic solvents and extent of base mismatching; the combination of parameters is more important than the absolute measure of any one alone.

The term “hybridization probes” as used herein are oligonucleotides capable of binding in a base-specific manner to a complementary strand of nucleic acid. Such probes include peptide nucleic acids, as described in Nielsen et al., Science 254, 1497-1500 (1991), and other nucleic acid analogs and nucleic acid mimetics.

The term “hybridizing specifically to” as used herein refers to the binding, duplexing, or hybridizing of a molecule only to a particular nucleotide sequence or sequences under stringent conditions when that sequence is present in a complex mixture (for example, total cellular) DNA or RNA.

The term “isolated nucleic acid” as used herein mean an object species invention that is the predominant species present (i.e., on a molar basis it is more abundant than any other individual species in the composition). Preferably, an isolated nucleic acid comprises at least about 50, 80 or 90% (on a molar basis) of all macromolecular species present. Most preferably, the object species is purified to essential homogeneity (contaminant species cannot be detected in the composition by conventional detection methods).

The term “linker group” (L) as used in connection with the present invention means to provide a linking function, which either alone or in conjunction with appropriate connecting groups, provide appropriate spacing of the Q group from the primary amine (Q-L-NH.sub.2) at such a length and in such a configuration as to allow appropriate reaction with the abasic DNA.

The term “monomer” as used herein refers to any member of the set of molecules that can be joined together to form an oligomer or polymer. The set of monomers useful in the present invention includes, but is not restricted to, for the example of (poly)peptide synthesis, the set of L-amino acids, D-amino acids, or synthetic amino acids. As used herein, “monomer” refers to any member of a basis set for synthesis of an oligomer. For example, dimers of L-amino acids form a basis set of 400 “monomers” for synthesis of polypeptides. Different basis sets of monomers may be used at successive steps in the synthesis of a polymer. The term “monomer” also refers to a chemical subunit that can be combined with a different chemical subunit to form a compound larger than either subunit alone.

The term “mRNA,” sometimes referred to “mRNA transcripts” as used herein, includes, but is not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from a mRNA transcript refers to a nucleic acid for whose synthesis the mRNA transcript or a subsequence thereof has ultimately served as a template. Thus, a cDNA reverse transcribed from a mRNA, an RNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of a gene or genes, cDNA reverse transcribed from the mRNA, cRNA transcribed from the cDNA, DNA amplified from the genes; RNA transcribed from amplified DNA, and the like.

The term “nucleic acid library,” sometimes referred to as a “array” as used herein refers to a synthetically or biosynthetically prepared collection of nucleic acids. Arrays may be used, inter alia, to screen for the presence or absence of a nucleic acid in a sample. Arrays of nucleic acids are available in a wide variety of different formats (for example, libraries of cDNAs or libraries of oligos tethered to resin beads, silica chips, or other solid supports). Additionally, the term “array” is meant to include those libraries of nucleic acids which can be prepared by spotting nucleic acids of essentially any length (for example, from 1 to about 1000 nucleotide monomers in length) onto a substrate. The term “nucleic acid” as used herein refers to a polymeric form of nucleotides of any length, either ribonucleotides, deoxyribonucleotides or peptide nucleic acids (PNAs), that comprise purine and pyrimidine bases, or other natural, chemically or biochemically modified, non-natural, or derivatized nucleotide bases. The backbone of the polynucleotide can comprise sugars and phosphate groups, as may typically be found in RNA or DNA, or modified or substituted sugar or phosphate groups. A polynucleotide may comprise modified nucleotides, such as methylated nucleotides and nucleotide analogs. The sequence of nucleotides may be interrupted by non-nucleotide components for example by nucleotide analogs that undergo non-traditional hybridization. Thus the terms nucleoside, nucleotide, deoxynucleoside and deoxynucleotide generally include analogs such as those described herein. These analogs are those molecules having some structural features in common with a naturally occurring nucleoside or nucleotide such that when incorporated into a nucleic acid or oligonucleoside sequence, they allow hybridization with a naturally occurring nucleic acid sequence in solution. Typically, these analogs are derived from naturally occurring nucleosides and nucleotides by replacing and/or modifying the base, the ribose or the phosphodiester moiety. The changes can be tailor made to stabilize or destabilize hybrid formation or enhance the specificity of hybridization with a complementary nucleic acid sequence as desired.

The term “nucleic acids” as used herein may include any polymer or oligomer of pyrimidine and purine bases, preferably cytosine, thymine, and uracil, and adenine and guanine, respectively. See Albert L. Lehninger, PRINCIPLES OF BIOCEMISTRY, at 793-800 (Worth Pub. 1982). Indeed, the present invention contemplates any deoxyribonucleotide, ribonucleotide or peptide nucleic acid component, and any chemical variants thereof, such as methylated, hydroxymethylated or glucosylated forms of these bases, and the like. The polymers or oligomers may be heterogeneous or homogeneous in composition, and may be isolated from naturally-occurring sources or may be artificially or synthetically produced. In addition, the nucleic acids may be DNA or RNA, or a mixture thereof, and may exist permanently or transitionally in single-stranded or double-stranded form, including homoduplex, heteroduplex, and hybrid states.

The term “oligonucleotide” or sometimes refer by “polynucleotide” as used herein refers to a nucleic acid ranging from at least 2, preferably at least 8, and more preferably at least 20 nucleotides in length or a compound that specifically hybridizes to a polynucleotide. Polynucleotides of the present invention include sequences of deoxyribonucleic acid (DNA) or ribonucleic acid (RNA) which may be isolated from natural sources, produced by recombination or artificially synthesized and mimetics thereof. A further example of a polynucleotide of the present invention may be peptide nucleic acid (PNA). The invention also encompasses situations in which there is a nontraditional base pairing such as Hoogsteen base pairing which has been identified in certain tRNA molecules and postulated to exist in a triple helix. “Polynucleotide” and “oligonucleotide” are used interchangeably in this application.

The term “polymorphism” as used herein refers to the occurrence of two or more genetically determined alternative sequences or alleles in a population. A polymorphic marker or site is the locus at which divergence occurs. Preferred markers have at least two alleles, each occurring at frequency of greater than 1%, and more preferably greater than 10% or 20% of a selected population. A polymorphism may comprise one or more base changes, an insertion, a repeat, or a deletion. A polymorphic locus may be as small as one base pair. Polymorphic markers include restriction fragment length polymorphisms, variable number of tandem repeats (VNTR's), hypervariable regions, minisatellites, dinucleotide repeats, trinucleotide repeats, tetranucleotide repeats, simple sequence repeats, and insertion elements such as Alu. For example, multi-tiled arrays, e.g., double tiled) are useful for detection of deletion, duplication or insertion polymorphisms.

The term “probe” as used herein refers to a surface-immobilized molecule that can be recognized by a particular target. See U.S. Pat. No. 6,582,908 for an example of arrays having all possible combinations of probes with 10, 12, and more bases. Examples of probes that can be investigated by this invention include, but are not restricted to, agonists and antagonists for cell membrane receptors, toxins and venoms, viral epitopes, hormones (for example, opioid peptides, steroids, etc.), hormone receptors, peptides, enzymes, enzyme substrates, cofactors, drugs, lectins, sugars, oligonucleotides, nucleic acids, oligosaccharides, proteins, and monoclonal antibodies.

The probes are oligonucleotide analogues which are capable of hybridizing with a target nucleic sequence by complementary base-pairing. Complementary base pairing includes sequence-specific base pairing, which comprises, e.g., Watson-Crick base pairing or other forms of base pairing such as Hoogsteen base pairing. The probes are attached by any appropriate linkage to a support. 3′ attachment is more usual as this orientation is compatible with the preferred chemistry used in solid phase synthesis of oligonucleotides and oligonucleotide analogues (with the exception of, e.g., analogues which do not have a phosphate backbone, such as peptide nucleic acids).

The term “solid support”, “support”, and “substrate” as used herein are used interchangeably and refer to a material or group of materials having a rigid or semi-rigid surface or surfaces. In many embodiments, at least one surface of the solid support will be substantially flat, although in some embodiments it may be desirable to physically separate synthesis regions for different compounds with, for example, wells, raised regions, pins, etched trenches, or the like. According to other embodiments, the solid support(s) will take the form of beads, resins, gels, microspheres, or other geometric configurations. See U.S. Pat. No. 5,744,305 for exemplary substrates.

The term “target” as used herein refers to a molecule that has an affinity for a given probe. Targets may be naturally-occurring or man-made molecules. Also, they can be employed in their unaltered state or as aggregates with other species. Targets may be attached, covalently or noncovalently, to a binding member, either directly or via a specific binding substance. Examples of targets which can be employed by this invention include, but are not restricted to, antibodies, cell membrane receptors, monoclonal antibodies and antisera reactive with specific antigenic determinants (such as on viruses, cells or other materials), drugs, oligonucleotides, nucleic acids, peptides, cofactors, lectins, sugars, polysaccharides, cells, cellular membranes, and organelles. Targets are sometimes referred to in the art as anti-probes. As the term targets is used herein, no difference in meaning is intended. A “Probe Target Pair” is formed when two macromolecules have combined through molecular recognition to form a complex.

While the methods of the invention has broad applications and are not limited to any particular detection methods, they are particularly suitable for detecting a large number of, such as more than 1000, 5000, 10,000, 50,000 different transcript features.

Fragmentation of nucleic acids comprises breaking nucleic acid molecules into smaller fragments. Fragmentation of nucleic acid may be desirable to optimize the size of nucleic acid molecules for certain reactions and destroy their three dimensional structure. For example, fragmented nucleic acids may be used for more efficient hybridization of target DNA to nucleic acid probes than non-fragmented DNA. According to a preferred embodiment, before hybridization to a microarray, target nucleic acid should be fragmented to sizes ranging from 50 to 200 bases long to improve target specificity and sensitivity. In a more preferred embodiment, the average size of such fragments, one must consider the components of the assay cocktail in partial fragments obtained is at least 10, 20, 30, 40, 50, 60, 70, 80, 100 or 200 nucleotides. To obtain fragments of such size, molar ratios of cold to hot nucleotides in the reaction mixture must be considered as well as the affinity constant, K.sub.m, of the enzyme at issue for the analogs at question and to the substrate. The greater the ratio of hot nucleotide to cold, the greater the level of incorporation that may be expected. The greater the ratio of incorporation of photoactive nucleotides, the smaller the size of resulting fragments.

mRNA or mRNA transcripts, as used herein, include, but not limited to pre-mRNA transcript(s), transcript processing intermediates, mature mRNA(s) ready for translation and transcripts of the gene or genes, or nucleic acids derived from the mRNA transcript(s). Transcript processing may include splicing, editing and degradation. As used herein, a nucleic acid derived from an mRNA transcript refers to a nucleic acid for whose synthesis the mRNA transcript or a subsequence thereof has ultimately served as a template. Thus, a cDNA reverse transcribed from an mRNA, a cRNA transcribed from that cDNA, a DNA amplified from the cDNA, an RNA transcribed from the amplified DNA, etc., are all derived from the mRNA transcript and detection of such derived products is indicative of the presence and/or abundance of the original transcript in a sample. Thus, mRNA derived samples include, but are not limited to, mRNA transcripts of the gene or genes, cDNA reverse transcribed from the mRNA, cRNA transcribed from the cDNA, DNA amplified from the genes, RNA transcribed from amplified DNA, and the like.

A fragment, segment, or DNA segment refers to a portion of a larger DNA polynucleotide or DNA. A polynucleotide, for example, can be broken up, or fragmented into, a plurality of segments. Various methods of fragmenting nucleic acid are well known in the art. These methods may be, for example, either chemical or physical in nature. Chemical fragmentation may include partial degradation with a DNase; partial depurination with acid; the use of restriction enzymes; intron-encoded endonucleases; DNA-based cleavage methods, such as triplex and hybrid formation methods, that rely on the specific hybridization of a nucleic acid segment to localize a cleavage agent to a specific location in the nucleic acid molecule; or other enzymes or compounds which cleave DNA at known or unknown locations. Physical fragmentation methods may involve subjecting the DNA to a high shear rate. High shear rates may be produced, for example, by moving DNA through a chamber or channel with pits or spikes, or forcing the DNA sample through a restricted size flow passage, e.g., an aperture having a cross sectional dimension in the micron or submicron scale. Other physical methods include sonication and nebulization. Combinations of physical and chemical fragmentation methods may likewise be employed such as fragmentation by heat and ion-mediated hydrolysis. See for example, Sambrook et al., “Molecular Cloning: A Laboratory Manual,” 3rd Ed. Cold Spring Harbor Laboratory Press, Cold Spring Harbor, N.Y. (2001) (“Sambrook et al.) which is incorporated herein by reference for all purposes. These methods can be optimized to digest a nucleic acid into fragments of a selected size range. Useful size ranges may be from 100, 200, 400, 700 or 1000 to 500, 800, 1500, 2000, 4000 or 10,000 base pairs. However, larger size ranges such as 4000, 10,000 or 20,000 to 10,000, 20,000 or 500,000 base pairs may also be useful.

Patents that describe synthesis techniques in specific embodiments include U.S. Pat. Nos. 5,412,087, 6,147,205, 6,262,216, 6,310,189, 5,889,165, and 5,959,098. Nucleic acid arrays are described in many of the above patents, but the same techniques are applied to polypeptide arrays.

The present invention also contemplates many uses for polymers attached to solid substrates. These uses include gene expression monitoring, profiling, library screening, genotyping and diagnostics. Gene expression monitoring, and profiling methods can be shown in U.S. Pat. Nos. 5,800,992, 6,013,449, 6,020,135, 6,033,860, 6,040,138, 6,177,248 and 6,309,822. Genotyping and uses therefore are shown in U.S. Ser. No. 60/319,253, 10/013,598, and U.S. Pat. Nos. 5,856,092, 6,300,063, 5,858,659, 6,284,460, 6,361,947, 6,368,799 and 6,333,179. Other uses are embodied in U.S. Pat. Nos. 5,871,928, 5,902,723, 6,045,996, 5,541,061, and 6,197,506.

The present invention also contemplates sample preparation methods in certain preferred embodiments. Prior to or concurrent with genotyping, the genomic sample may be amplified by a variety of mechanisms, some of which may employ PCR. See, e.g., PCR Technology: Principles and Applications for DNA Amplification (Ed. H. A. Erlich, Freeman Press, NY, N.Y., 1992); PCR Protocols: A Guide to Methods and Applications (Eds. Innis, et al., Academic Press, San Diego, Calif., 1990); Mattila et al., Nucleic Acids Res. 19,4967 (1991); Eckert et al., PCR Methods and Applications 1, 17 (1991); PCR (Eds. McPherson et al., IRL Press, Oxford); and U.S. Pat. Nos. 4,683,202, 4,683,195, 4,800,159 4,965,188, and 5,333,675, and each of which is incorporated herein by reference in their entireties for all purposes. The sample may be amplified on the array. See, for example, U.S. Pat. No. 6,300,070 and U.S. patent application Ser. No. 09/513,300, which are incorporated herein by reference.

Other suitable amplification methods include the ligase chain reaction (LCR) (e.g., Wu and Wallace, Genomics 4, 560 (1989), Landegren et al., Science 241, 1077 (1988) and Barringer et al. Gene 89:117 (1990)), transcription amplification (Kwoh et al., Proc. Natl. Acad. Sci. USA 86, 1173 (1989) and WO88/10315), self-sustained sequence replication (Guatelli et al., Proc. Nat. Acad. Sci. USA, 87, 1874 (1990) and WO90/06995), selective amplification of target polynucleotide sequences (U.S. Pat. No. 6,410,276), consensus sequence primed polymerase chain reaction (CP-PCR) (U.S. Pat. No. 4,437,975), arbitrarily primed polymerase chain reaction (AP-PCR) (U.S. Pat. No. 5,413,909, 5,861,245) and nucleic acid based sequence amplification (NABSA). (See, U.S. Pat. Nos. 5,409,818, 5,554,517, and 6,063,603, each of which is incorporated herein by reference). Other amplification methods that may be used are described in, U.S. Pat. Nos. 5,242,794, 5,494,810, 4,988,617 and in U.S. Ser. No. 09/854,317, each of which is incorporated herein by reference.

Additional methods of sample preparation and techniques for reducing the complexity of a nucleic sample are described in Dong et al., Genome Research 11, 1418 (2001), in U.S. Pat. Nos. 6,361,947, 6,391,592 and U.S. patent application Ser. Nos. 09/916,135, 09/920,491, 09/910,292, and 10/013,598.

Methods for conducting polynucleotide hybridization assays have been well developed in the art. Hybridization assay procedures and conditions will vary depending on the application and are selected in accordance with the general binding methods known including those referred to in: Maniatis et al. Molecular Cloning: A Laboratory Manual (2.sup.nd Ed. Cold Spring Harbor, N.Y, 1989); Berger and Kimmel Methods in Enzymology, Vol. 152, Guide to Molecular Cloning Techniques (Academic Press, Inc., San Diego, Calif., 1987); Young and Davism, P.N.A.S, 80: 1194 (1983). Methods and apparatus for carrying out repeated and controlled hybridization reactions have been described in U.S. Pat. Nos. 5,871,928, 5,874,219, 6,045,996 and 6,386,749, 6,391,623 each of which are incorporated herein by reference The present invention also contemplates signal detection of hybridization between ligands in certain preferred embodiments. See U.S. Pat. Nos. 5,143,854, 5,578,832; 5,631,734; 5,834,758; 5,936,324; 5,981,956; 6,025,601; 6,141,096; 6,185,030; 6,201,639; 6,218,803; and 6,225,625, in U.S. Patent application 60/364,731 and in PCT Application PCT/US99/06097 (published as WO99/47964), each of which also is hereby incorporated by reference in its entirety for all purposes.

Methods and apparatus for signal detection and processing of intensity data are disclosed in, for example, U.S. Pat. Nos. 5,143,854, 5,547,839, 5,578,832, 5,631,734, 5,800,992, 5,834,758; 5,856,092, 5,902,723, 5,936,324, 5,981,956, 6,025,601, 6,090,555, 6,141,096, 6,185,030, 6,201,639; 6,218,803; and 6,225,625, in U.S. Patent application 60/364,731 and in PCT Application PCT/US99/06097 (published as WO99/47964), each of which also is hereby incorporated by reference in its entirety for all purposes.

The practice of the present invention may also employ conventional biology methods, software and systems. Computer software products of the invention typically include computer readable medium having computer-executable instructions for performing the logic steps of the method of the invention. Suitable computer readable medium include floppy disk, CD-ROM/DVD/DVD-ROM, hard-disk drive, flash memory, ROM/RAM, magnetic tapes and etc. The computer executable instructions may be written in a suitable computer language or combination of several languages. Basic computational biology methods are described in, e.g. Setubal and Meidanis et al., Introduction to Computational Biology Methods (PWS Publishing Company, Boston, 1997); Salzberg, Searles, Kasif, (Ed.), Computational Methods in Molecular Biology, (Elsevier, Amsterdam, 1998); Rashidi and Buehler, Bioinformatics Basics: Application in Biological Science and Medicine (CRC Press, London, 2000) and Ouellette and Baxevanis Bioinformatics: A Practical Guide for Analysis of Gene and Proteins (Wiley & Sons, Inc., 2.sup.nd ed., 2001).

The present invention may also make use of various computer program products and software for a variety of purposes, such as probe design, management of data, analysis, and instrument operation. See, U.S. Pat. Nos. 5,593,839, 5,795,716, 5,733,729, 5,974,164, 6,066,454, 6,090,555, 6,185,561, 6,188,783, 6,223,127, 6,229,911 and 6,308,170. Additionally, the present invention may have preferred embodiments that include methods for providing genetic information over networks such as the Internet as shown in U.S. patent application Ser. Nos. 10/197,621, 10/063,559 (U.S. Publication No. 20020183936), Ser. Nos. 10/065,868, 10/328,818, 10/328,872, 10/423,403 60/349,546, and 60/482,389.

In any application in which multiple tiles of a double-tiled array wilt be bound by each fluorescent polynucleotide, it is straightforward to determine by inspection whether inner or outer 30-mers are bound. The technique is not limited to only two nonadjacent oligonucleotides per feature; higher orders of tiling are also possible. Each feature can be split into multiple smaller sub-features, e.g. 100-mer features could readily be subdivided into four 25-mers, forming diagonals or non-linear designs. Whole genome tiling arrays in particular are in need of methods to increase array feature density—for example, Cheng et al. recently reported analysis of 10 human chromosomes at 5 bp resolution, requiring 98 arrays per sample.⁸ Using similar arrays with triple-tiled 25 mers, the number of arrays required per sample would be reduced 3-fold. Thus, the double- (or multiple-) tiling technique can dramatically increase the depth and the breadth of coverage of a wide range of microarray experiments.

In diagnostic applications, oligonucleotide analogue arrays (e.g., arrays on chips, slides or beads) are used to determine whether there are any differences between a reference sequence and a target oligonucleotide, e.g., whether an individual has a mutation or polymorphism in a known gene. As discussed supra, the oligonucleotide target is optionally a nucleic acid such as a PCR amplicon, which comprises one or more nucleotide analogues. In one embodiment, arrays are designed to contain probes exhibiting complementarity to one or more selected reference sequence whose sequence is known. The arrays are used to read a target sequence comprising either the reference sequence itself or variants of that sequence. Any polynucleotide of known sequence is selected as a reference sequence. Reference sequences of interest include sequences known to include mutations or polymorphisms associated with phenotypic changes having clinical significance in human patients. For example, the CFTR gene and P53 gene in humans have been identified as the location of several mutations resulting in cystic fibrosis or cancer respectively. Other reference sequences of interest include those that serve to identify pathogen microorganisms and/or are the site of mutations by which such microorganisms acquire drug resistance (e.g., the HIV reverse transcriptase gene for HIV resistance). Other reference sequences of interest include regions where polymorphic variations are known to occur (e.g., the Droop region of mitochondrial DNA). These reference sequences also have utility for, e.g., forensic, cladistic, or epidemiological studies.

Although an array of oligonucleotide analogue probes is usually laid down in rows and columns for simplified data processing, such a physical arrangement of probes on the solid substrate is not essential. Provided that the spatial location of each probe in an array is known, the data from the probes is collected and processed to yield the sequence of a target irrespective of the actual physical arrangement of the probes on, e.g., a chip. In processing the data, the hybridization signals from the respective probes is assembled into any conceptual array desired for subsequent data reduction, whatever the physical arrangement of probes on the substrate.

### EXAMPLES

### Array Design

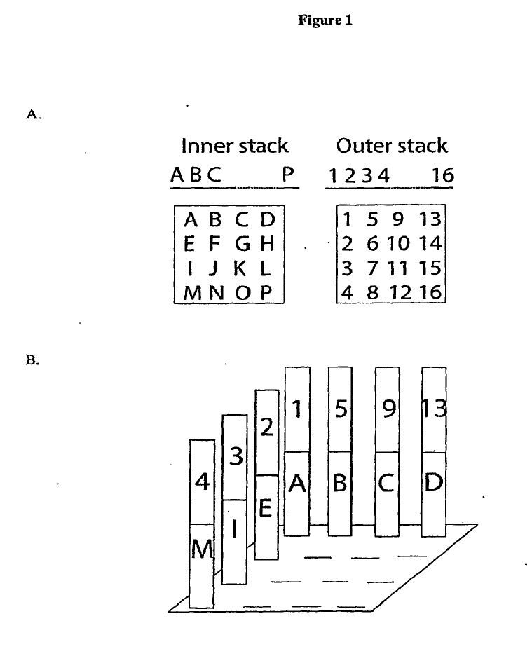

In one aspect, described are 60-mer features (e.g., probes) for DNA oligonucleotide microarrays that each comprise two concatenated 30-mers. The “inner” 30-mers (e.g., the 30 nt bound to the slide) form an “inner stack” and are unrelated in genomic coordinates to the “outer” 30-mers. An “outer stack” of 30-mers, which was computationally grafted onto the inner stack, produces 30-mer pairs concatenated into 60-mers (e.g., the probes) (FIG. 1a, b). The positions of the sequences can be randomized to reduce potential spatial artifacts. For example, bound (e.g., hybridized or associated) fluorescent polynucleotides (e.g., sample) can span a contiguous set of sequences, illuminating a line of features. By examining fluorescent feature adjacency, it can be determined whether the inner or outer 30-mer hybridized to the sample, as for example, a fluorescent molecule binding one outer 30-mer will bind several adjacent outer 30-mers, illuminating a line of features. The features, depending on which stack is illuminated will be in, for example, a horizontal, vertical, diagonal line or other arranged or shaped designs). There is, of course, the possibility of a spurious match across the junction of the 30-mers, but simulations and practical experiments revealed no instances of this. In one embodiment, to prevent or reduce, even further the possibility of a spurious match across a junction of the probes, a spacer (e.g., chemical) could be linked at the junction between the probes to prevent cross-hybridization.

In one aspect, described is a 44,000 feature (60-mer) array (Agilent Technologies Inc.) spanning the entire Saccharomyces cerevisiae genome. Repetitive sequences were masked at the feature selection stage (described below). The 30-mers were separated by an average spacing of 123 nucleotides (this spacing is based on the unmasked i.e. nonrepetitive component of the genome). Positive controls included Ty1 sequences, arranged to read “TY” in the center of the array when bound to labeled Ty1 DNA (two other sets of Ty1 controls are present, in both horizontal and vertical arrangements).

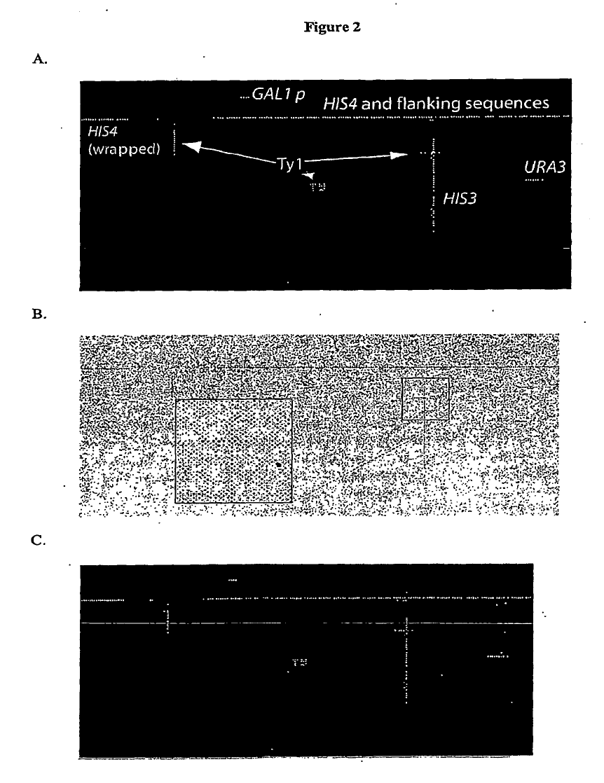

A few yeast sequences were chosen as the sample to be hybridized to the array (see below). Some of the sequences were predicted to bind to inner 30-mers and illuminating horizontal lines, and others binding outer 30-mers in vertical lines. A “virtual array,” an in silico model of the ideal hybridization of the test DNA, as shown in (FIG. 2a), included both horizontal and vertical lines and illustrated the layout of the central Ty1 control features. The technique was experimentally confirmed (FIG. 2b), and demonstrated that the inner and outer 30-mers of each 60-mer can be separately and specifically bound. The signal intensity for inner and outer 30-mers was similar, suggesting binding to each half of the 60-mer. In a virtual overlay (FIG. 2c) we it was seen that the actual array was, qualitatively, in agreement with the predicted array.

### Transcript Profiling

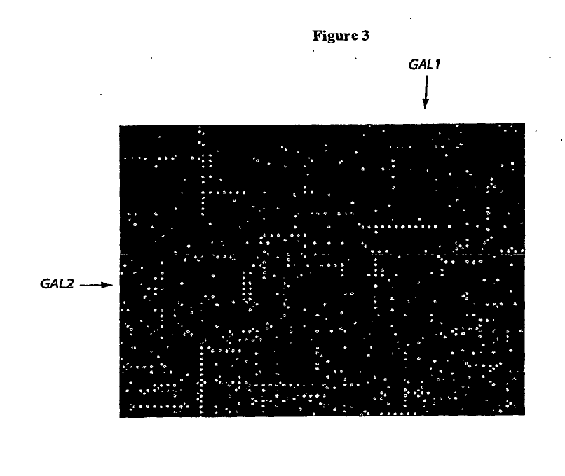

One yeast culture was grown in galactose and another in glucose (as the sole carbon source), and the expressed sequences of the cultures were examined in a cyanine 3-cyanine 5 (Cy3-Cy5) two-color labeling using a double-tiled microarray, attempting to reproduce the steady-state galactose vs. glucose results of Lashkari et al,⁵ (FIG. 3). The RNA from galactose-grown cells was labeled with Cy5 (red) and the glucose with Cy3 (green). Most of the lines were yellow, as expected, indicating that most genes are expressed at comparable levels in the two cultures; however, there were clearly visible red lines present on the array, indicating successful detection of genes upregulated in the galactose-induced culture.

### Deconvolution

Analyzing the double-tiled, two-color array provided a computational challenge, as the final fluorescence seen for any one composite feature represents the sum of the fluorescence of the two conjoined 30-mer features, which could in principle bind to two separate molecules in the fluorescent extract. To deconvolute the fluorescence intensities, yᵢ was first defined as the normalized log ratio of the red versus green intensity for feature i. Then it was assumed that the contribution of each component was additive and used the following linear model: yᵢ=θ_{gi1}+θgᵢ₂+ε, where gᵢ₁ is the index of the inside gene and gᵢ₂ is the index of the outside gene, θ_{gi} is the relative expression for each gene, and E represents measurement error. The goal was to estimate θ_{gi} for all gᵢ. The errors were assumed independently identically distributed with mean 0 and used the least squares method. Specifically, the 44,290×6,606 design matrix, X, was created with rows representing features and columns representing the open reading frames (ORFs) in the Saccharomyces Gene Database annotation file, with a 1 placed at position xⱼₖ if ORF j is represented on feature k. It was then denoted the 6606×1 vector of true relative gene expression for each gene with Θ and the 44,290×1 vector of log ratios and errors with y and ε respectively. The model could then be written as:

y=XΘ+\vec{ε}

and the least squares solution is:

\hat{Θ}=(X^{T}X)⁻¹X^{T}y

This is the matrix form of the multiple regression equations. Notice that solving this equation involves inverting a 6,606×6,606 matrix, which is not a trivial task even with today's computer power, as it requires at least 216 billion operations in R (if done using Gaussian elimination). However, as X is an extremely sparse matrix the equation may be solved in a few seconds using the Matrix package in R, for example shown on the world wide web at http://cran.r-projectorg/src/contrib/Descriptions/Matrix.html.

### Double-Tiled Versus Conventional Tiling Array Data

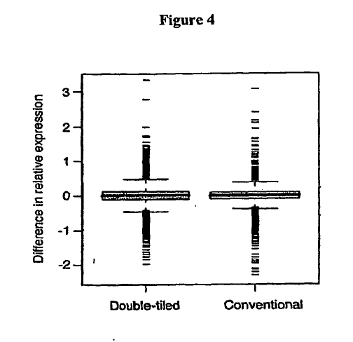

To evaluate the concordance and reproducibility of data collected using the double-tiled and conventional single-tiled 60-mer arrays, the same galactose- and glucose-grown, labeled RNA extracts were hybridized to Agilent custom 60-mer (conventional) whole genome yeast arrays. Box plots were created (FIG. 4) showing the distribution of the difference between estimated relative expression obtained from replicate RNA samples for the conventional and double-tiled arrays. It can readily be seen from the box plots that the quality of the double-tiled army signals was very comparable to that of the single-tiled array. Once analyzed in this way, the data was ranked first by their signal to noise ratio defined as the moderated t-statistic⁶ and then, for the top 150 consistent genes, by rank order of average log ratio. This second ranking was done because many genes with very small and possibly insignificant effects were consistent across all of the arrays. The results (Table 1) are consistent with those of Lashkari et al.⁵; for example, it was found that genes involved in galactose metabolism and transport, as well as ATP synthase subunits, were the highest up-regulated transcripts in the galactose-grown cells, while a glucose transporter, among other genes, was down-regulated.

TABLE 1
Gene expression in the galactose- and glucose-grown samples.

| Rank | SGD ID | Gene name | M | P value |
|---|---|---|---|---|
| 1 | YBR020W | GAL1 | 2.5 | 0.00017 |
| 2 | YLR081W | GAL2 | 2.0 | 0.00075 |
| 3 | YKL085W | MDH1 | 1.3 | 0.0027 |
| 4 | YDL181W | INH1 | 1.2 | 0.00073 |
| 5 | YOR120W | GCY1 | 1.0 | 0.010 |
| 6 | YJR121W | ATP2 | 1.0 | 0.0012 |
| 7 | YDL004W | ATP16 | 1.0 | 0.0056 |
| 8 | YBR039W | ATP3 | 0.94 | 0.0069 |
| 9 | YBL099W | ATP1 | 0.92 | 0.0023 |
| 10 | YJL166W | QCR8 | 0.89 | 0.0022 |
| 11 | YHR033W | | 0.84 | 0.011 |
| 12 | YBR118W | TEF2 | 0.81 | 0.00073 |
| 13 | YCL040W | GLK1 | 0.75 | 0.0037 |
| 14 | YFR049W | YMR31 | 0.71 | 0.012 |
| 15 | YDR178W | SDH4 | 0.68 | 0.013 |
| 16 | YHR051W | COX6 | 0.67 | 0.0013 |
| 17 | YDR010C | | 0.64 | 0.0072 |
| 18 | YDR007W | TRP1 | 0.60 | 0.0027 |
| 19 | YDR009W | GAL3 | 0.59 | 0.0060 |
| 20 | YPL273W | SAM4 | −0.45 | 0.0070 |
| −20 | YCR051W | | −0.46 | 0.020 |
| −19 | YHR179W | OYE2 | −0.47 | 0.025 |
| −18 | YDR037W | KRS1 | −0.49 | 0.014 |
| −17 | YGL209W | MIG2 | −0.49 | 0.010 |
| −16 | YNL067W | RPL9B | −0.50 | 0.00073 |
| −15 | YLR367W | RPS22B | −0.51 | 0.012 |
| −14 | YBR106W | PHO88 | −0.52 | 0.0041 |
| −13 | YMR186W | HSC82 | −0.52 | 0.0041 |
| −12 | YLR175W | CBF5 | −0.52 | 0.014 |
| −10 | YGL255W | ZRT1 | −0.55 | 0.0072 |
| −9 | YLR134W | PDC5 | −0.55 | 0.0048 |
| −8 | YDR033W | MRH1 | −0.56 | 0.0034 |
| −7 | YHR072W-A | NOP10 | −0.60 | 0.0062 |
| −6 | Ty1 | | −0.62 | 0.020 |
| −5 | YAL038W | CDC19 | −0.69 | 0.00069 |
| −4 | YHL015W | RPS20 | −0.73 | 0.00045 |
| −3 | YMR011W | HXT2 | −0.77 | 0.014 |
| −2 | YOL109W | ZEO1 | −0.95 | 0.00069 |
| −1 | YLR109W | AHP1 | −1.2 | 0.00073 |

The top 20 and bottom 20 expressed genes in the double-tiled and the single-tiled arrays, rank-ordered by log ratio (all of these are also in the top 150 when ranked by consistency between the arrays). M is the mean log ratio of expression across all four arrays.

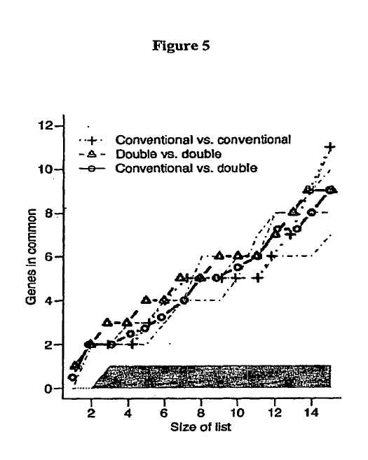

As a more extensive test of statistical concordance between the double-tiled and single-tiled arrays, the differential expression data was evaluated in the form of a CAT plot⁷ (correspondence at the top, FIG. 5). Correspondence is a simple and highly informative way of comparing lists of data and is defined here as the number of genes in common in the lists made by ranking genes by their log-ratio and keeping the top N members of the lists.

It can readily be seen that concordance at the top between replicates of both the single- and double-tiled arrays was good, as the curves were well above the height of the yellow line, which demarcates the 99.9^{th} percentile under the null hypothesis (no concordance). The concordance was also at the top between the double- and single-tiled array data was nearly indistinguishable from the intraplatform data, which is remarkable given that the two array platforms include completely independent sets of sequence features. This provided a direct demonstration that statistically, double-tiled arrays perform as well as single-tiled arrays in this yeast whole genome transcript profiling experiment.

### Design of Double-Tiled Array

In one exemplary array, 80,897 30-bp features were chosen from the yeast genome in three steps. First, the yeast genome was masked; retrotransposons and long terminal repeats (LTRs), telomeres, and X and Y′ elements were not included in the sequences used for feature selection. Second, Primer3⁹ was used to choose oligonucleotides with the lowest likelihood of conformational problems; this process did not yield enough oligonucleotides spaced at the required high density. Finally, the remaining oligonucleotides (9.7% of the total) were evenly spaced across the gaps without regard to sequence properties. The 30-mer sequences were arranged in sequence order and first from left to right, then top to bottom along the microarray, until the inner stack was filled, then the final 60-mers were created by appending the remaining 30-mers, in order from top to bottom, then left to right, forming the outer stack. These double-tiled 44K arrays were synthesized by Agilent Technologies (AMADJD# 13371).

### Design of Single-Tiled Arrays

As above, features were chosen from the masked yeast genome; these 60-mer features were, as above, first chosen by Primer3 and then chosen randomly to create enough features at the required density to tile the yeast genome and are described in detail elsewhere (Wheelan S J, Scheifele L Z, Martinez-Murillo F, Irizarry R A, Boeke J D, “Eukaryotic Transposable Elements and Genome Evolution Special Feature: Transposon insertion site profiling chip (CIP-chip),” Proc Natl Acad Sci USA. 2006 103(47):17632-7.). The single-tiled 44K arrays were synthesized by Agilent Technologies (AMADID #13306).

### Hybridization of Plasmids to Double-Tiled Array

A mixture of plasmids B154 (HIS4 and flanking YCL sequences), YIp1 (HIS3), and pEDB9c (Ty1, URA3, and GAL1 promoter) was used to query the array. Each plasmid was digested in three parallel reactions with AluI, MspI, and HpyCH4V. The resulting fragments were heat-inactivated, pooled and labeled for hybridization to the microarray as follows: 200 ng DNA was incubated with 36 μg random hexamer in a 23 μl reaction at 100° C. for 2 minutes, then 4° C. for 4 minutes. The labeling reaction then proceeded with the addition of 5 μL 10×dNTP (8 mM dATP, dCTP, dGTP, 4 mM dUTP), 5 μl 10× Klenow buffer, 7 μl Klenow (exo-) fragment (5U/μl), 7 μl H₂O, and 2 μl Cy5 dUTP, and was incubated at 37° C. for 2 hours. The reaction was stopped with 5 μl 10.5 M EDTA pH 8.0. The products were mixed with 450 μl TE and concentrated on a Microcon YM-30 (Amicon catalog #42410) column. The products were washed again with 450 μl TE and 10 μl sheared salmon sperm DNA (10 mg/ml), and concentrated again on a Microcon column. The resulting volume was adjusted to 26 μl with the addition of H₂O, and SDS and SSC were added to final concentrations of 3×SSC and 0.3% SDS, in a total volume of 32.5 μl. After incubation at 100° C. for 90 seconds and then 37° C. for 30 minutes, the products were spotted onto microarrays and covered with 22×60 mm cover slips (VWR catalog #48393 070).

The microarrays were hybridized overnight in a humid chamber at 55° C. In the morning, the arrays were washed in 2×SSC, 0.03% SDS for 5 minutes at 55° C., then in 1×SSC for 5 minutes at room temperature, and finally in 0.2×SSC for 5 minutes at room temperature. Microarrays were allowed to air dry and then scanned in a GenePix 400013 scanner (Axon Instruments), using GenePix Pro 5.1 software.

### Galactose Induction and RNA Preparation

To examine expression levels in galactose-grown versus glucose-grown yeast, we first grew an overnight culture of BY4743 yeast in yeast extract/peptone (YEP)+2% raffinose, to an OD₆₀₀ of 5.5. YEP+2% galactose and YEP+2% dextrose cultures were then inoculated with the overnight culture to a starting OD₆₀₀ of 0.25 or 0.125, and the cultures were grown at 30° C. to OD₆₀₀ 0.6. Cells were pelleted by centrifugation in 50 ml conical tubes at 1300 rcf for 5 minutes at 4° C., resuspended in 1 ml ice-cold water and pelleted again in a microcentrifuge at 13,000 rpm at 4° C., and then the supernatant was decanted and the cells were frozen on dry ice. RNA was prepared as follows, after the method of Schmitt et al. ° with modifications.

Cells were thawed on ice and resuspended in 400 μl TES (10 mM Tris-HCl, pH 7.5, mM ethylenediaminetetraacetic acid (EDTA), and 0.5% SDS); 400 μl acid phenol/chloroform was added, and after vortexing briefly, the extracts were incubated at 65° C. for 60 minutes with brief, occasional vortexing. The extracts were placed on ice for 5 minutes, then spun at top speed in a microcentrifuge at 4° C. for 5 minutes. The aqueous layer was transferred to a new tube and extracted once more with acid phenol/chloroform. RNA was precipitated out of the aqueous layer: the aqueous layer was transferred to a new tube and 40 μl 3 M sodium acetate, pH 5.3 and 1 ml ice cold 100% ethanol were added, and the tube was placed at 80° C. overnight. After a 5-minute spin at 4° C., the pellet was washed in ice-cold 70% ethanol and spun again for 5 minutes at 4° C. The pellet was resuspended in 50 μl DEPC-treated water and further purified using a Qiagen RNeasy kit. Finally, the RNA was treated with DNase I by incubating 50 μl RNA with 10 μl 10× DNase I buffer, 1 μl DNase I, 2 μl RNasin, and 37 μl water at 37° C. for 30 minutes. 10 μl 25 mM EDTA was added before heat inactivation at 65° C. for 15 minutes. After 1 minute on ice, the RNA was cleaned up with 100 μl phenol/chloroform/isoamyl alcohol, vortexed, and centrifuged for 5 minutes in a microcentrifuge at 13,000 rpm at 4° C. The aqueous layer was taken to a new tube and 400 μl ice-cold 100% ethanol and 10 μl M sodium acetate pH 5.3 were added, and the RNA was precipitated overnight at −80° C., then washed with 70% ethanol and resuspended in 30 μl diethyl pyrocarbonate-treated (DEPC) water. Finally, the RNA concentration was adjusted to 500 ng/μl.

### Two-Color Arrays

Yeast RNA was processed using a modification of the Agilent Low RNA Input Fluorescent Linear Amplification protocol (Agilent Technologies Kit, Protocol version 3.3, July 2005; Maitreya Dunham, personal communication).

400 ng of total RNA were denatured for 10 minutes at 65° C. in the presence of T7 promoter primer and nuclease-free water in a total volume of 11.5 μl, and snap cooled for 5 minutes on ice. The cDNA synthesis was done using MMLV-RT, DTT, 10 mM dNTP and RNaseOUT (Agilent Technologies Kit) at 40° C. for 2 hours, followed by an enzyme inactivation step for 15 minutes at 65° C. To each sample, 2.4 μl of either cyanine 3-CTP (10 mM) or cyanine 5-CTP (10 mM) were added and incorporated in an in vitro transcription step at 40° C. for 2 hours using PEG, RNaseOUT, T7 RNA polymerase and inorganic pyrophosphatase to generate labeled cRNA (reagents are included in the Agilent Low RNA Input Linear Amplification Kit; concentrations and sources are proprietary). Amplified cRNA was then purified using QIAGEN's QIAquick spin columns as described in the RNeasy Mini Kit (QIAGEN). After confirming that the specific activity of the labeled cRNA was between 10 and 20 pmols per μg of cRNA, a total of 850 ng labeled cRNA from each sample (Cy3-Cy5 labeled) were mixed and fragmented using the Gene Expression Hybridization Kit (Agilent Technologies) and hybridized to the array for 17 hours at 45° C. (for the double-tiled array) or 55° C. (for the conventional 60-mer array) in the dark. The arrays were then washed in solution A (700 ml dH2O, 300 ml 20×SSPE, 20% N-lauroylsarcosine) for 1 minute at RT, followed by 1 minute in wash B (997 ml dH2O, 3 ml 20×SSPE, 0.25 ml 20% N-lauroylsarcosine) at RT, and by a 30 second wash in Acetonitrile (100%, anhydrous) The arrays were scanned using the Axon GenePix 4,000B scanner (Axon Instruments) and the images were analyzed using GenePix Pro 6.0.

Microarray platform and sample data have been deposited in GEO (accession GSE5721).

### REFERENCES

1. Bertone, P., Gerstein, M. & Snyder, M. Applications of DNA tiling arrays to experimental genome annotation and regulatory pathway discovery. Chromosome Res. 13, 259-274 (2005).
2. Bertone, P. et al. Global identification of human transcribed sequences with genome tiling arrays. Science 306, 2242-2246 (2004).
3. Mockler, T. C. et al. Applications of DNA tiling arrays for whole-genome analysis. Genomics 85, 1-15 (2005).
4. Shoemaker, D. D. et al. Experimental annotation of the human genome using microarray technology. Nature 409, 922-927 (2001).
5. Lashkari, D. A. et al. Yeast microarrays for genome wide parallel genetic and gene expression analysis. Proc. Natl. Acad. Sci. U.S.A. 94, 13057-13062 (1997).
6. Smyth, G. K Linear models and empirical bayes methods for assessing differential expression in microarray experiments. Stat. Appl. Genet. Mol. Biol. 3, Article3 (2004).
7. Irizarry, R. A. et al. Multiple-laboratory comparison of microarray platforms. Nat. Methods 2, 345-350 (2005).
8. Cheng, J. et al. Transcriptional maps of 10 human chromosomes at 5-nucleotide resolution. Science 308, 1149-1154 (2005).
9. Rozen, S. & Skaletsky, H. Primer3 on the WWW for general users and for biologist programmers. Methods Mol. Biol. 132, 365-386 (2000).
10. Schmitt, M. E., Brown, T. A. & Trumpower, B. L. A rapid and simple method for preparation of RNA from Saccharomyces cerevisiae. Nucleic Acids Res. 18, 3091-3092 (1990).

1. A multi-tiled nucleic acid array, comprising an immobilized array of nucleic acid features, wherein each feature comprises an inner probe and an outer probe, wherein the inner and outer probes are unrelated in genomic coordinates.

2. The multi-tiled nucleic acid array of claim 1, wherein one of the inner or the outer probe is arranged horizontally and the other is arranged vertically.

3. The multi-tiled nucleic acid array of claim 1, wherein the features of the array further comprise middle probes between the inner and the outer probes, wherein the probes are unrelated in genomic coordinates.

4. The multi-tiled nucleic acid array of claim 3, wherein the features of the array further comprise second middle probes between the inner and the middle probes, wherein the probes are unrelated in genomic coordinates.

5. The multi-tiled nucleic acid array of claim 1, further comprising at least one positive control feature.

6. The multi-tiled nucleic acid array of claim 1, further comprising at least one negative control feature.

7. The multi-tiled nucleic acid array of claim 1, wherein the multi-tiled array comprises from between about 100 to about 3 billion features.

8. The multi-tiled nucleic acid array of claim 1, wherein the multi-tiled array comprises from between about 10,000 to 10 million features. 10 million to 3 billion.

9. A multi-tiled nucleic acid array, comprising an immobilized array of nucleic acid features, wherein the features comprise an inner probe, a middle probe, and an outer probe, wherein the probes are unrelated in genomic coordinates.

10. The multi-tiled array of claim 9, wherein the probes are from between about 10 nucleotides to about 50 nucleotides in length.

11-12. (canceled)

13. A multi-tiled nucleic acid array, comprising an immobilized array of nucleic acid features, wherein the features comprise four probes, an inner probe a middle probe, and an outer probe, wherein the probes are unrelated in genomic coordinates.

14. The multi-tiled array of claim 13, wherein the probes are from between about 10 nucleotides to about 50 nucleotides in length.

15-16. (canceled)

17. A multi-tiled nucleic acid array, comprising an immobilized array of nucleic acid features, wherein the features comprise at least two probes unrelated in genomic coordinates.

18. A method of expression profiling, comprising:
providing a multi-tiled array,
hybridizing a labeled sample to the array; and
analyzing the array.

19-28. (canceled)

29. A method of constructing a multi-tiled array, comprising:
selecting probe sequences;
arranging inner probe sequences in sequence order, and
appending outer probe sequences in sequence order to the inner probe sequences.

30-39. (canceled)

40. A method of array based evaluation of a sample, comprising:
providing a multi-tiled array;
hybridizing a sample to the array; and
deconvoluting signal intensities.

41-46. (canceled)

47. A method of polymorphism analysis comprising providing a multi-tiled nucleic acid array of probes comprising a first set of probes spanning each of a collection of polymorphic sites in known sequences of unknown function and complementary to a first allelic forms of the sites, and a second set of probes spanning each of the polymorphic sites in the collection and complementary to second allelic forms of the sites, wherein the collection of polymorphic sites includes at least 10 unlinked polymorphic sites; and hybridizing a nucleic acid sample from a subject to the array of probes and analyzing the hybridization intensities of probes in the first and second probe sets to determine a profile of polymorphic forms present in the individual.

48-56. (canceled)
